(19) United States
(12) Patent Application Publication
(10) Pub. No.: US 2022/0396094 A1
(43) Pub. Date: Dec. 15, 2022

(54) PNEUMATIC TIRE

(71) Applicant: The Yokohama Rubber Co., LTD., Tokyo (JP)

(72) Inventors: Masahiro NARUSE, Kanagawa (JP); Yuki NAGAHASHI, Kanagawa (JP)

(21) Appl. No.: 17/756,342

(22) PCT Filed: Nov. 25, 2020
(86) PCT No.: PCT/JP2020/043767

§ 371 Date: May 23, 2022

(30) Foreign Application Priority Data
Nov. 27, 2019 (JP) 2019-214375
Nov. 27, 2019 (JP) 2019-214376

(51) Int. Cl. B60C 5/14; B60C 19/00; B29D 30/06; B29C 33/64

(52) U.S. Cl. CPC B60C 5/14; B60C 19/00; B29D 30/0654; B29C 33/64; B60C 2019/004

(57) ABSTRACT

A pneumatic tire includes a transponder extending along a circumferential direction embedded between a position (P1) located on an outer side of and 15 mm away from an upper end of a bead core in a radial direction and a position (P2) located on an inner side of and 5 mm away from an end of a belt layer in the radial direction, and a tire inner surface in which a release agent layer made of a release agent is formed has a surface electric resistivity of 10⁹ Ω·cm to 10¹⁵ Ω·cm. The transponder extending along the circumferential direction is embedded between the position (P1) and the position (P2), and the amount of silicon of the release agent at least in the tire inner surface corresponding to an embedment section for the transponder is 10.0 wt % or less or a thickness of the release agent is 100 μm or less.

### TECHNICAL FIELD

The present technology relates to a pneumatic tire embedded with a transponder, and relates particularly to a pneumatic tire that can ensure communication performance of the transponder.

### BACKGROUND ART

In a pneumatic tire, in a case where a green tire is vulcanized by using a bladder, the bladder is likely to bond to an inner surface of the green tire, and thus, a release agent is applied to the inner surface of the green tire to prevent bonding of the green tire and the bladder. In general, the release agent includes materials such as carbon, mica, and silicone, and among these materials, carbon has the characteristics of being likely to reflect radio waves.

In a case where a transponder is embedded inside such a pneumatic tire (for example, see Japan Unexamined Patent Publication No. H07-137510), communication with a transponder using a reader/writer is accompanied by a problem in that a release agent layer (particularly a carbon layer) formed in the tire inner surface causes reflection of radio waves, which mutually cancels one another to reduce communication distance.

### SUMMARY

The present technology provides a pneumatic tire that can ensure communication performance of a transponder.

A pneumatic tire according to a first embodiment of the present technology includes a tread portion extending in a tire circumferential direction and having an annular shape, a pair of sidewall portions respectively disposed on both sides of the tread portion, and a pair of bead portions each disposed on an inner side of the sidewall portions in a tire radial direction, a bead filler being disposed on an outer circumference of a bead core of each bead portion, at least one carcass layer being mounted between the pair of bead portions, a plurality of belt layers being disposed on an outer circumferential side of the carcass layer in the tread portion, and a release agent layer made of a release agent being formed in a tire inner surface, a transponder that extends along the tire circumferential direction being embedded between a position located on an outer side of and 15 mm away from an upper end of the bead core in the tire radial direction and a position located on an inner side of and 5 mm away from an end of the belt layer in the tire radial direction, and the tire inner surface in which the release agent layer is formed having a surface electric resistivity R ranging from 10⁹ Ω·cm to 10¹⁵ Ω·cm.

Additionally, a pneumatic tire according to a second embodiment of the present technology includes a tread portion extending in a tire circumferential direction and having an annular shape, a pair of sidewall portions respectively disposed on both sides of the tread portion, and a pair of bead portions each disposed on an inner side of the sidewall portions in a tire radial direction, a bead filler being disposed on an outer circumference of a bead core of each bead portion, at least one carcass layer being mounted between the pair of bead portions, and a plurality of belt layers being disposed on an outer circumferential side of the carcass layer in the tread portion, a transponder that extends along the tire circumferential direction being embedded between a position located on an outer side of and 15 mm away from an upper end of the bead core in the tire radial direction and a position located on an inner side of and 5 mm away from an end of the belt layer in the tire radial direction, and an amount of silicon of a release agent detected by fluorescence X-ray analysis at least in a tire inner surface corresponding to an embedment section for the transponder being 10.0 wt % or less.

Furthermore, a pneumatic tire according to a third embodiment of the present technology includes a tread portion extending in a tire circumferential direction and having an annular shape, a pair of sidewall portions respectively disposed on both sides of the tread portion, and a pair of bead portions each disposed on an inner side of the sidewall portions in a tire radial direction, a bead filler being disposed on an outer circumference of a bead core of each bead portion, at least one carcass layer being mounted between the pair of bead portions, and a plurality of belt layers being disposed on an outer circumferential side of the carcass layer in the tread portion, a transponder that extends along the tire circumferential direction being embedded between a position located on an outer side of and 15 mm away from an upper end of the bead core in the tire radial direction and a position located on an inner side of and 5 mm away from an end of the belt layer in the tire radial direction, and a release agent having a thickness of 100 μm or less, the thickness detected by an electron microscope at least in a tire inner surface corresponding to an embedment section for the transponder.

The inventors of the present technology found that specifying the surface electric resistivity of the tire inner surface is effective in ensuring the communication performance of the transponder. Furthermore, the inventors of the present technology found that specifying the amount or thickness of the release agent adhering to the tire inner surface is effective in ensuring the communication performance of the transponder.

In the first embodiment of the present technology, the transponder extending along the tire circumferential direction is embedded between the position located on the outer side of and 15 mm away from the upper end of the bead core in the tire radial direction and the position located on the inner side of and 5 mm away from the end of the belt layer in the tire radial direction. This makes metal interference less likely to occur, allowing the communication performance of the transponder to be ensured. In a case where the release agent layer formed in the tire inner surface contains carbon, the surface electric resistivity of the tire inner surface tends to decrease. However, when the surface electric resistivity R of the tire inner surface in which the release agent layer is formed is set in the range from 10⁹ Ω·cm to 10¹⁵ Ω·cm, the content of carbon contained in the release agent layer can be adjusted, and mutual cancellation of radio waves during communication caused by carbon can be suppressed, contributing to improvement of the communication performance of the transponder.

In the second or third embodiment of the present technology, the transponder extending along the tire circumferential direction is embedded between the position located on the outer side of and 15 mm away from the upper end of the bead core in the tire radial direction and the position located on the inner side of and 5 mm away from the end of the belt layer in the tire radial direction. This makes metal interference less likely to occur, allowing the communication performance of the transponder to be ensured. In particular, the amount of silicon of the release agent detected by fluorescence X-ray analysis at least in the tire inner surface corresponding to the embedment section for the transponder is 10.0 wt % or less, or the thickness of the release agent detected by the electron microscope is 100 μm or less. Thus, a minute amount of release agent adheres to the tire inner surface, allowing suppression of mutual cancellation of radio waves caused by the release agent to contribute to improving the communication performance of the transponder.

In the pneumatic tire according to the first embodiment of the present technology, preferably, the release agent layer includes 95 w t % or more of insulator. Thus, the communication performance of the transponder can be effectively improved.

Preferably, an amount of silicone constituting the insulator of the release agent layer is 80 wt % or more. Thus, the communication performance of the transponder can be effectively improved.

Preferably, the release agent layer has a greater electric resistivity than a rubber member adjacent to the release agent layer. Thus, the communication performance of the transponder can be effectively improved.

Preferably, the release agent layer has a relative dielectric constant of 10 or less. Thus, the communication performance of the transponder can be effectively improved.

Preferably, the release agent layer has a thickness ranging from 20 μm to 200 μm. Thus, the communication performance of the transponder can be effectively improved.

Preferably, the amount of silicone detected in the release agent layer by fluorescence X-ray analysis ranges from 10 wt % to 25 wt %. Thus, the communication performance of the transponder can be effectively improved.

In the pneumatic tire according to the second or third embodiment of the present technology, preferably, the amount of silicon in the release agent ranges from 0.1 wt % to 10.0 wt %, or the thickness of the release agent ranges from 0.1 μm to 100 μm. The release agent in the tire inner surface can be completely removed by, for example, buffing the tire inner surface after vulcanization, or bonding a film to the inner surface of a green tire in advance, applying the release agent to the inner surface of the green tire to which the film has been bonded, and peeling off the film after vulcanization. However, in this case, air retention properties of the tire may be degraded. In contrast, the communication performance of the transponder can be ensured without extremely degrading the air retention properties.

In the pneumatic tire according to the first, second, or third embodiment of the present technology, preferably, a center of the transponder is disposed 10 mm or more away from a splice portion of a tire component in the tire circumferential direction. Accordingly, tire durability can be effectively improved.

Preferably, the transponder is disposed between the carcass layer and a rubber layer disposed in the sidewall portion on an outer side of the carcass layer, the transponder in contact with the rubber layer. This suppresses attenuation of radio waves during communicating, allowing the communication performance of the transponder to be effectively improved.

Preferably, a distance between a cross-sectional center of the transponder and a tire outer surface is 2 mm or more. Accordingly, tire durability can be effectively improved, and tire scratch resistance can be improved.

In the pneumatic tire, preferably, an innerliner layer is disposed on the tire inner surface along the carcass layer, and the transponder is disposed between the carcass layer and the innerliner layer. In a case where the transponder is disposed on an outer side of a turned-up portion of the carcass layer in a tire width direction, the transponder may be damaged due to damage to the sidewall portion, but in this regard, the transponder can be prevented from being damaged due to damage to the sidewall portion.

Preferably, a distance between the cross-sectional center of the transponder and the tire inner surface is 1 mm or more. Accordingly, tire durability can be effectively improved, and the transponder can be prevented from being damaged due to damage to the innerliner layer while the tire is mounted on a rim.

Preferably, the transponder is disposed between a position located on an outer side of and 5 mm away from an upper end of the bead filler in the tire radial direction and a position located on the inner side of and 5 mm away from the end of the belt layer in the tire radial direction. Accordingly, the transponder is disposed in a flex zone with a small rubber gauge. However, this region is subjected to less attenuation of radio waves during communication of the transponder, allowing the communication performance of the transponder to be effectively improved.

Preferably, the transponder is covered with a coating layer, and the coating layer has a relative dielectric constant of 7 or less. Accordingly, the transponder is protected by the coating layer, allowing the durability of the transponder to be improved and also ensuring radio wave transmissivity of the transponder, to allow the communication performance of the transponder to be sufficiently ensured.

Preferably, the transponder is covered with a coating layer, and the coating layer has a thickness of from 0.5 mm to 3.0 mm. Accordingly, the communication performance of the transponder can be sufficiently ensured without making the tire outer surface or the tire inner surface uneven.

Preferably, the transponder includes an IC substrate storing data and an antenna transmitting and receiving data, and the antenna has a helical shape. Accordingly, it can conform deformation of the tire during traveling, allowing the durability of the transponder to be improved.

In the first embodiment of the present technology, for the surface electric resistivity (Ω·cm) of the tire inner surface, a test piece (a length of 50 mm, a width of 50 mm, and a thickness of 2 mm) is cut out from the tire, a voltage of 0.1 V is applied at both ends across the test piece, and the surface electric resistivity is measured by using a resistance measuring machine at in measurement environment at 23° C. and 60% RH. Additionally, the electric resistivity (Ω·cm) of the rubber member is measured in accordance with JIS (Japanese Industrial Standard)-K6271.

### BRIEF DESCRIPTION OF DRAWINGS

FIG. 1 is a meridian cross-sectional view illustrating the pneumatic tire according to an embodiment of the present technology.

FIG. 2 is a meridian cross-sectional view schematically illustrating the pneumatic tire of FIG. 1.

FIG. 3 is a equator line cross-sectional view schematically illustrating the pneumatic tire of FIG. 1.

FIG. 4 is an enlarged cross-sectional view illustrating a transponder embedded in the pneumatic tire of FIG. 1.

FIGS. 5A and 5B are perspective views illustrating a transponder that can be embedded in a pneumatic tire according to an embodiment of the present technology.

FIG. 6 is a meridian cross-sectional view illustrating a modified example of a pneumatic tire according to an embodiment of the present technology.

FIG. 7 is an enlarged cross-sectional view illustrating a transponder embedded in the pneumatic tire of FIG. 6.

FIG. 8 is an explanatory diagram illustrating the position in a tire radial direction of a transponder in a test tire.

### DETAILED DESCRIPTION

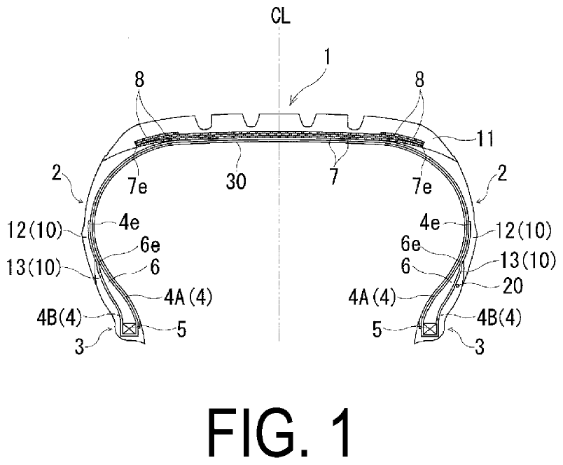

A configuration of a first embodiment of the present technology will be described in detail below with reference to the accompanying drawings. FIGS. 1 to 4 illustrate a pneumatic tire according to an embodiment of the present technology.

As illustrated in FIG. 1, the pneumatic tire according to the present embodiment includes a tread portion 1 extending in a tire circumferential direction and having an annular shape, a pair of sidewall portions 2 disposed on both sides of the tread portion 1, and a pair of bead portions 3 disposed on an inner side in a tire radial direction of the pair of sidewall portions 2.

At least one carcass layer 4 (one layer in FIG. 1) formed by arranging a plurality of carcass cords in the radial direction is mounted between the pair of bead portions 3. Organic fiber cords of nylon, polyester, or the like are preferably used as the carcass cords constituting the carcass layer 4. Bead cores having an annular shape are embedded within the bead portions 3, and bead fillers 6 made of a rubber composition and having a triangular cross-section are disposed on the outer peripheries of the bead cores 5.

On the other hand, a plurality of belt layers 7 (two layers in FIG. 1) are embedded on a tire outer circumferential side of the carcass layer 4 of the tread portion 1. The belt layers 7 include a plurality of reinforcing cords that are inclined with respect to the tire circumferential direction, and the reinforcing cords are disposed between layers so as to intersect each other. In the belt layers 7, the inclination angle of the reinforcing cords with respect to the tire circumferential direction is set to fall within a range of from 10° to 40°, for example. Steel cords are preferably used as the reinforcing cords of the belt layers 7.

To improve high-speed durability, at least one belt cover layer 8 (two layers in FIG. 1) formed by arranging reinforcing cords at an angle of, for example, 5° or less with respect to the tire circumferential direction is disposed on a tire outer circumferential side of the belt layers 7. In FIG. 1, the belt cover layer 8 located on the inner side in the tire radial direction constitutes a full cover that covers the entire width of the belt layers 7, and the belt cover layer 8 located on an outer side in the tire radial direction constitutes an edge cover layer that covers only end portions of the belt layers 7. Organic fiber cords such as nylon and aramid are preferably used as the reinforcing cords of the belt cover layer 8.

In the pneumatic tire described above, both ends 4e of the carcass layer 4 are folded back from the tire inner side to the tire outer side around the bead cores 5, and are disposed wrapping around the bead cores 5 and the bead fillers 6. The carcass layer 4 includes: a body portion 4A corresponding to a portion extending from the tread portion 1 through each of the sidewall portions 2 to each of the bead portions 3; and a turned-up portion 4B corresponding to a portion turned up around the bead core 5 at each of the bead portions 3 and extending toward each sidewall portion 2 side.

Additionally, on a tire inner surface, an innerliner layer 9 is disposed along the carcass layer 4. Furthermore, a cap tread rubber layer 11 is disposed in the tread portion 1, a sidewall rubber layer 12 is disposed in the sidewall portion 2, and a rim cushion rubber layer 13 is disposed in the bead portion 3. A rubber layer 10 disposed on the outer side of the carcass layer 4 in the sidewall portion 2 includes the sidewall rubber layer 12 and the rim cushion rubber layer 13.

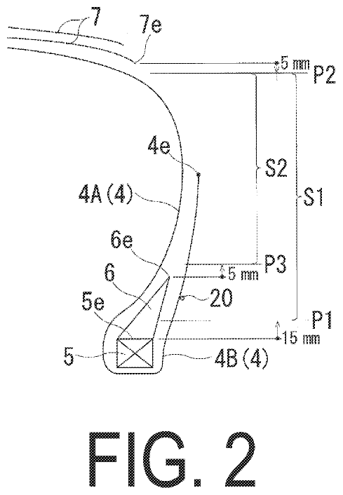

Additionally, in the pneumatic tire described above, a transponder 20 is embedded between a position P1 located on the outer side of and 15 mm away from an upper end 5e of the bead core 5 in the tire radial direction (the end portion on the outer side in the tire radial direction) and a position P2 located on the inner side of and 5 mm away from an end 7e of the belt layer 7 in the tire radial direction. In other words, the transponder 20 is disposed in a region S1 illustrated in FIG. 2. Additionally, the transponder 20 extends in the tire circumferential direction. The transponder 20 may be disposed inclined at an angle ranging from −10° to 10° with respect to the tire circumferential direction.

Note that in the embodiment of FIGS. 1 and 2, an example has been illustrated in which the end 4e of the turned-up portion 4B of the carcass layer 4 is disposed halfway up the sidewall portion 2. However, the end 4e of the turned-up portion 4B of the carcass layer 4 may be disposed laterally to the bead core 5. In such a low turn-up structure, the transponder 20 may be disposed between the carcass layer 4 (more specifically, the bead filler 6) and the sidewall rubber layer 12 or the rim cushion rubber layer 13 in contact with the rubber layer.

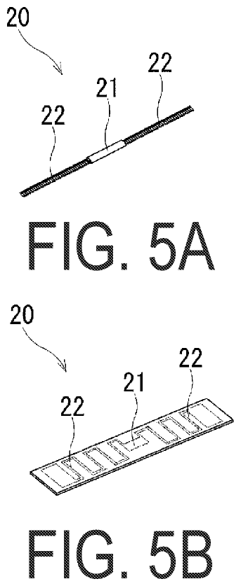

As the transponder 20, for example, a radio frequency identification (RFID) tag can be used. As illustrated in FIGS. 5A and 5B, the transponder 20 includes an IC substrate 21 that stores data and an antenna 22 that transmits and receives data in a non-contact manner. By using the transponder 20 as described above to write or read information related to the tire on a timely basis, the tire can be efficiently managed. Note that “RFID” refers to an automatic recognition technology including: a reader/writer including an antenna and a controller; and an ID (identification) tag including an IC (integrated circuit) substrate and an antenna, the automatic recognition technology allowing data to be communicated in a wireless manner.

The overall shape of the transponder 20 is not particularly limited, and for example, a pillar- or plate-like shape can be used as illustrated in FIGS. 5A and 5B. In particular, the transponder 20 having a pillar-like shape illustrated in FIG. 5A is suitable as it can conform deformation of the tire in many directions. In this case, the antenna 22 of the transponder 20 projects from each of both end portions of the IC substrate 21 and exhibits a helical shape. Accordingly, the transponder 20 can conform deformation of the tire during traveling, allowing the durability of the transponder 20 to be improved. Furthermore, by appropriately changing the length of the antenna 22, the communication performance can be ensured.

Furthermore, in the pneumatic tire described above, a release agent layer 30 including a release agent is formed in the tire inner surface. The tire inner surface has a surface electric resistivity R ranging from 10⁹ Ω·cm to 10¹⁵ Ω·cm. Preferably, the tire inner surface has a surface electric resistivity R ranging from 10¹⁴ Ω·cm to 10¹⁵ Ω·cm. By specifying the range of the surface electric resistivity R of the tire inner surface in this way, the content of carbon contained in the release agent layer 30 can be adjusted. Carbon contained in the release agent layer 30 tends to reduce the surface electric resistivity R of the tire inner surface. Note that carbon has an electric resistivity (volume resistivity) of 10-1 cm.

A release agent containing no carbon is preferably used, but a release agent containing less than 5 wt % of carbon may be used. In particular, the release agent may contain an insulator formed of silicone, mica, and talc, and the amount of silicone constituting the insulator is 80 wt % or more. The silicone component includes organopolysiloxanes, and the examples can include dialkylpolysiloxane, alkylphenylpolysiloxane, alkyl aralkyl polysiloxane, and 3,3,3-trifluoropropylmethylpolysiloxane. The dialkylpolysiloxane is, for example, dimethylpolysiloxane, diethylpolysiloxane, methylisopropylpolysiloxane, and methyldodecylpolysiloxane. The alkylphenylpolysiloxane is, for example, methylphenylpolysiloxane, a dimethylsiloxane methylphenylsiloxanecopolymer, and dimethylsiloxane-diphenylsiloxane copolymer. The alkyl aralkyl polysiloxane is, for example, methyl(phenylethyl)polysiloxane and methyl(phenylpropyl)polysiloxane. One kind or two or more kinds of these organopolysiloxanes may be used in combination.

In the pneumatic tire described above, the transponder 20 extending along the tire circumferential direction is embedded between the position P1 located on the outer side of and 15 mm away from the upper end 5e of the bead core 5 in the tire radial direction and the position P2 located on the inner side of and 5 mm away from the end 7e of the belt layer 7 in the tire radial direction, thus making metal interference less likely to occur to ensure the communication performance of the transponder 20. In a case where the release agent layer 30 formed in the tire inner surface contains carbon, the surface electric resistivity of the tire inner surface tends to decrease. However, when the surface electric resistivity R of the tire inner surface in which the release agent layer 30 is formed is set in the range from 10⁹ Ω·cm to 10¹⁵ Ω·cm, the content of carbon contained in the release agent layer 30 can be adjusted, and mutual cancellation of radio waves during communication caused by carbon can be suppressed, contributing to improvement of the communication performance of the transponder 20.

In this regard, in a case where the transponder 20 is disposed further on the inner side than the position P1 in the tire radial direction, metal interference with the rim flange occurs, leading to the tendency to degrade the communication performance of the transponder 20. Additionally, in a case where the transponder 20 is disposed further on the outer side than the position P2 in the tire radial direction, metal interference with the belt layer 7 occurs, leading to the tendency to degrade the communication performance of the transponder 20.

In the pneumatic tire described above, the release agent layer 30 preferably includes 95 wt % or more of insulator, and furthermore, the amount of silicone constituting the insulator of the release agent layer 30 is more preferably 80 wt % or more. By making up the release agent as described above, the communication performance of the transponder 20 can be effectively improved. Note that for the silicone, mica, and talc constituting the insulator, the silicone has an electric resistivity (volume resistivity) of from 10¹⁴ Ω·cm to 10¹⁵ Ω·cm, the mica has an electric resistivity of from 10¹⁰ Ω·cm to 10¹³ Ω·cm, and the talc has an electric resistivity of from 10¹⁴ Ω·cm or more.

Additionally, the electric resistivity of the release agent layer 30 is preferably greater than the electric resistivity of the rubber member adjacent to the release agent layer 30. For example, the rubber member adjacent to the release agent layer 30 is the innerliner layer 9 formed from butyl rubber. By setting the electric resistivity of the release agent layer 30 as described above, the communication performance of the transponder 20 can be effectively improved.

Furthermore, the release agent layer 30 preferably has a relative dielectric constant of 10 or less, more preferably 8 or less, and most preferably 4 or less. By properly setting the relative dielectric constant of the release agent layer 30 as described above, the communication performance of the transponder 20 can be effectively improved. Note that for the silicone, mica, and talc constituting the release agent layer 30, the silicone has a relative dielectric constant of from 2.60 to 2.75, the mica has a relative dielectric constant of from 5.0 to 8.0, and the talc has a relative dielectric constant of from 1.6 to 2.0.

In the pneumatic tire described above, preferably, the release agent layer 30 has a thickness ranging from 20 μm to 200 μm, or the amount of silicone detected by fluorescence X-ray analysis in the release agent layer 30 ranges from 10 wt % to 25 wt %. By properly setting the thickness or amount of the release agent layer 30 as described above, the communication performance of the transponder 20 can be effectively improved.

In this regard, the thickness of the release agent layer 30 can be detected by using an electron microscope. In a case where the thickness of the release agent using the electron microscope is measured, a sample of the pneumatic tire cut out along the tire width direction is used, and the thickness of the sample is measured at a plurality of sections (for example, four sections in the tire circumferential direction and three sections in the tire width direction). Then, the thickness (average thickness) of the release agent is calculated by averaging the measurement values obtained at the plurality of sections.

Additionally, in the first embodiment of the present technology, the amount of silicone (silicon), corresponding to a main component of a typical release agent, is used as an indicator to specify the amount of the release agent layer 30 in the tire inner surface. The amount of silicone (silicon) can be detected using fluorescence X-ray analysis, and in general, the fluorescence X-ray analysis includes a fundamental parameter method (FP method) and a calibration curve method. The first embodiment of the present technology employs the FP method. In a case where the amount of the release agent (silicon) is measured, sheet samples (dimensions: a width of 70 mm, a length of 100 mm) are used that are obtained by peeling off the carcass layer and the innerliner layer at a plurality of sections of the pneumatic tire described above (for example, a total of seven sections including four sections in the tire circumferential direction and three sections in the tire width direction), from each sheet sample, measurement samples (dimensions: a width ranging from 13 mm to 15 mm, a length ranging from 35 mm to 40 mm) are further sampled at a total of five sections, including four corners and one central portion, and the amount of release agent is measured using a fluorescence X-ray analyzer for each measurement sample. Then, measurement values for five measurement samples are averaged for each of the sheet samples to calculate the amount of release agent per sheet sample, and each of the calculated values ranges from 10 wt % to 25 wt %. X-ray fluorescence particles have an intrinsic energy proportional to an atomic number, allowing an element to be identified by measuring the intrinsic energy. Specifically, the intrinsic energy of silicon is 1.74±0.05 keV. Note that the number of X-ray fluorescence particles (X-ray intensity) of the release agent (silicon) is in a range of from 0.1 cps/μA to 1.5 cps/μA.

In contrast, when the thickness of the release agent layer 30 is less than 20 μm, the tire inner surface is likely to have an abnormal appearance. When the thickness of the release agent layer 30 is greater than 200 μm, radio waves tend to be attenuated to reduce the communication distance of the transponder 20. When the amount of silicone contained in the release agent layer 30 is less than 10 wt %, the tire inner surface tends to have an abnormal appearance. When the amount of silicone contained in the release agent layer 30 is greater than 25 wt %, radio waves tend to be attenuated to reduce the communication distance of the transponder 20.

In the pneumatic tire described above, the transponder 20 is preferably disposed between the carcass layer 4 and the rubber layer 10 in contact with the rubber layer 10. In other words, the transponder 20 is preferably disposed between the carcass layer 4 and the sidewall rubber layer 12 or the rim cushion rubber layer 13 as an arrangement region in the tire width direction such that the transponder 20 contacts the rubber layer. The transponder 20 disposed as described above suppresses attenuation of radio waves during communication, allowing the communication performance of the transponder 20 to be effectively improved.

Additionally, the transponder 20 may be disposed between a position P3 located on the outer side of and 5 mm away from an upper end 6e of the bead filler 6 in the tire radial direction and the position P2 located on the inner side of and 5 mm away from the end 7e of the belt layer 7 in the tire radial direction In other words, the transponder 20 may be disposed in a region S2 illustrated in FIG. 2. The region S2 is a flex zone with a small rubber gauge, and the transponder 20 disposed in the region S2 mitigates attenuation of radio waves during communication of the transponder 20, allowing the communication performance of the transponder 20 to be effectively improved.

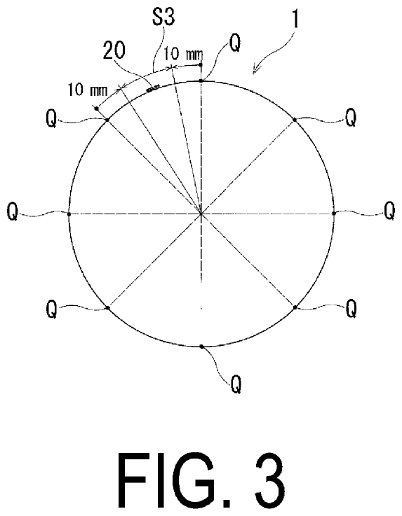

As illustrated in FIG. 3, a plurality of splice portions formed by overlaying end portions of the tire component are present on the tire circumference. FIG. 3 illustrates positions Q of each of the splice portions in the tire circumferential direction. The center of the transponder 20 is preferably disposed 10 mm or more away from the splice portion of the tire component in the tire circumferential direction. In other words, the transponder 20 may be disposed in a region S3 illustrated in FIG. 3. Specifically, the IC substrate 21 constituting the transponder 20 may be located 10 mm or more away from the position Q in the tire circumferential direction. Furthermore, the entire transponder 20 including the antenna 22 is more preferably located 10 mm or more away from the position Q in the tire circumferential direction, and the entire transponder 20 covered with the coating rubber is most preferably located 10 mm or more away from the position Q in the tire circumferential direction. Additionally, the tire component disposed away from the transponder 20 may preferably be the innerliner layer 9, the carcass layer 4, the sidewall rubber layer 12, or the rim cushion rubber layer 13, which may be disposed adjacent to the transponder 20. By disposing the transponder 20 away from the splice portion of the tire component as described above, tire durability can be effectively improved.

Note that in the embodiment of FIG. 3, an example in which the positions Q of the splice portions of each tire component in the tire circumferential direction are disposed at equal intervals, but no such limitation is intended. The positions Q in the tire circumferential direction can be set at any positions, and in either case, the transponder 20 is disposed 10 mm or more away from the splice portion of each tire component in the tire circumferential direction.

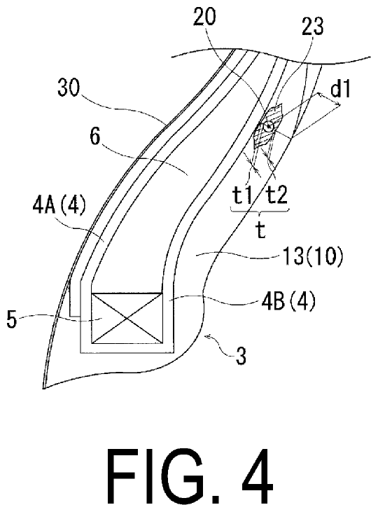

As illustrated in FIG. 4, a distance d1 between the cross-sectional center of the transponder 20 and the tire outer surface is preferably 2 mm or more. By spacing the transponder 20 and the tire outer surface apart from each other as described above, tire durability can be effectively improved, and tire scratch resistance can be improved.

Additionally, the transponder 20 may be covered with a coating layer 23. The coating layer 23 coats the entire transponder 20 while holding both front and rear sides of the transponder 20. The coating layer 23 may be formed from rubber having physical properties identical to those of the rubber constituting the sidewall rubber layer 12 or the rim cushion rubber layer 13 or from rubber having different physical properties. The transponder 20 is protected by the coating layer 23 as described above, and thus the durability of the transponder 20 can be improved.

In the pneumatic tire described above, with the transponder 20 covered with the coating layer 23, the coating layer 23 preferably has a relative dielectric constant of 7 or less and more preferably from 2 to 5. By properly setting the relative dielectric constant of the coating layer 23 as described above, radio wave transmissivity can be ensured during emission of a radio wave by the transponder 20, effectively improving the communication performance of the transponder 20. Note that the rubber constituting the coating layer 23 has a relative dielectric constant of from 860 MHz to 960 MHz at ambient temperature. In this regard, the ambient temperature is 23±2° C. and 60% 5% RH in accordance with the standard conditions of the JIS standard. The relative dielectric constant of the rubber is measured after 24 hour treatment at 23° C. and 60% RH. The range from 860 MHz to 960 MHz described above corresponds to the allocated frequency of the RFID in the current UHF (ultra high frequency) band, but in a case where the allocated frequency is changed, the relative dielectric constant in the range of the allocated frequency may be specified as described above.

In addition, with the transponder 20 covered with the coating layer 23, a thickness t of the coating layer 23 preferably ranges from 0.5 mm to 3.0 mm, and more preferably ranges from 1.0 mm to 2.5 mm. In this regard, the thickness t of the coating layer 23 is the thickness of the rubber at a position where the rubber includes the transponder 20, and is, for example, a rubber thickness obtained by summing a thickness t1 and a thickness t2 on a straight line extending through the center of the transponder 20 and orthogonally to the tire outer surface as illustrated in FIG. 4. By properly setting the thickness t of the coating layer 23 as described above, the communication performance of the transponder 20 can be effectively improved without making the tire outer surface or the tire inner surface uneven. In this regard, when the thickness t of the coating layer 23 is less than 0.5 mm, the effect of improving the communication performance of the transponder 20 fails to be obtained. In contrast, when the thickness t of the coating layer 23 exceeds 3.0 mm, the tire outer surface or the tire inner surface is uneven, and this is not preferable. Note that the cross-sectional shape of the coating layer 23 is not particularly limited and that for example, a triangular shape, a rectangular shape, a trapezoidal shape, and a spindle shape can be adopted. The coating layer 23 in FIG. 4 has a substantially spindle-shaped cross-sectional shape.

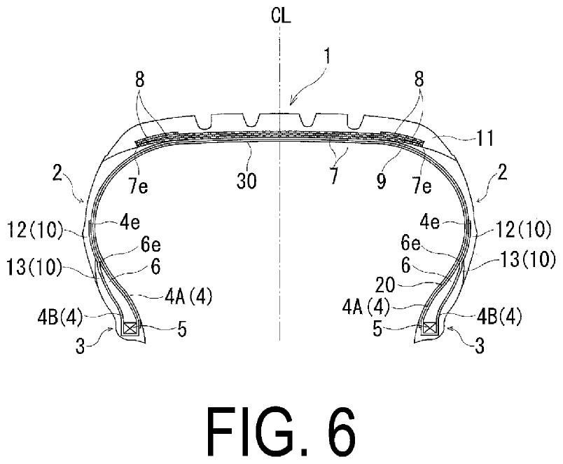

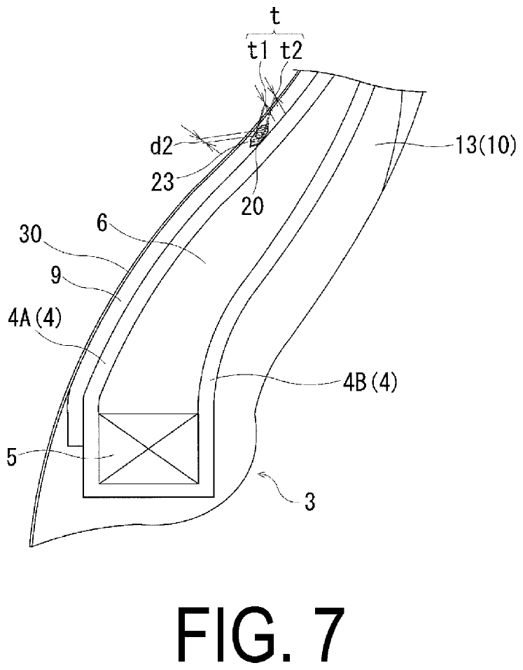

FIGS. 6 and 7 illustrate a modified example of a pneumatic tire according to an embodiment of the present technology. In FIGS. 6 and 7, components identical to those illustrated in FIGS. 1 to 4 are denoted by the identical reference signs, and detailed descriptions of these components are omitted.

As illustrated in FIG. 6, the transponder 20 is embedded between the carcass layer 4 and the innerliner layer 9. In a case where the transponder is disposed between the carcass layer and the sidewall rubber layer or the rim cushion rubber layer in contact with the rubber layer, the transponder may be damaged due to damage to the sidewall portion. In contrast, in a case where the transponder 20 is embedded between the carcass layer 4 and the innerliner layer 9 as illustrated in FIG. 6, the transponder 20 can be prevented from being damaged due to damage to the sidewall portion 2.

As illustrated in FIG. 7, a distance d2 between the cross-sectional center of the transponder 20 and the tire inner surface is preferably 1 mm or more. By spacing the transponder 20 and the tire inner surface apart from each other as described above, tire durability can be effectively improved, and the transponder 20 can be prevented from being damaged due to damage to the innerliner layer 9 while the tire is mounted on a rim.

In the embodiment described above, an example of a pneumatic tire including a single carcass layer is illustrated. However, no such limitation is intended, and the pneumatic tire may include two carcass layers. Additionally, in the embodiment described above, an example has been illustrated in which the end 4e of the turned-up portion 4B of the carcass layer 4 is disposed beyond the upper end 6e of the bead filler 6 and halfway up the sidewall portion 2. However, no such limitation is intended, and the end 4e can be disposed at any height.

Now, configurations of the second and third embodiments of the present technology will be described using FIGS. 1 to 7. Identical reference signs are used for components identical to the corresponding components of the pneumatic tire according to the first technology, and detailed descriptions of those components will be omitted.

In the pneumatic tires according to the second and third embodiments of the present technology, the transponder 20 is embedded between the position P1 located on the outer side of and 15 mm away from the upper end 5e of the bead core 5 in the tire radial direction and the position P2 located on the inner side of and 5 mm away from the end 7e of the belt layer 7 in the tire radial direction. In other words, the transponder 20 is disposed in the region S1 illustrated in FIG. 2. Additionally, the transponder 20 extends in the tire circumferential direction.

In the pneumatic tire according to the second embodiment of the present technology, at least in a portion of the tire inner surface corresponding to the embedment section for the transponder 20, the amount of silicon of the release agent forming the release agent layer 30 is 10.0 wt % or less. In the second embodiment of the present technology, the amount of silicon, corresponding to a main component of a typical release agent, is used as an indicator to specify the amount of the release agent in the tire inner surface and the FP method is adopted as is the case with the first embodiment of the present invention.

In the pneumatic tire according to the third embodiment of the present technology, at least in a portion of the tire inner surface corresponding to the embedment section for the transponder 20, the thickness of the release agent forming the release agent layer 30 is 100 μm or less. The thickness of the release agent can be detected by using the electron microscope. In a case where the thickness of the release agent is measured using the electron microscope, the thickness (average thickness) of the release agent is calculated as is the case with the first embodiment of the present technology.

In the pneumatic tires according to the second or third embodiments of the present technology described above, the transponder 20 extending along the tire circumferential direction is embedded between the position P1 located on the outer side of and 15 mm away from the upper end 5e of the bead core 5 in the tire radial direction and the position P2 located on the inner side of and 5 mm away from the end 7e of the belt layer 7 in the tire radial direction. This makes metal interference less likely to occur, allowing the communication performance of the transponder 20 to be ensured. In particular, at least in the tire inner surface corresponding to the embedment section for the transponder 20, the amount of silicon of the release agent detected by fluorescence X-ray analysis is 10.0 wt % or less, or the thickness of the release agent detected by the electron microscope is 100 μm or less. Thus, a minute amount of release agent adheres to the tire inner surface, allowing suppression of mutual cancellation of radio waves during communication caused by the release agent to contribute to improving the communication performance of the transponder 20.

In the pneumatic tire described above, the amount of silicon of the release agent preferably ranges from 0.1 wt % to 10.0 wt %, or the thickness of the release agent preferably ranges from 0.1 μm to 100 μm. The release agent in the tire inner surface can be completely removed by, for example, buffing the tire inner surface after vulcanization, or bonding a film to the inner surface of a green tire in advance, applying the release agent to the inner surface of the green tire to which the film has been bonded, and peeling off the film after vulcanization. However, in this case, air retention properties of the tire may be degraded. In contrast, the communication performance of the transponder 20 can be ensured without extremely degrading the air retention properties.

Now, a method for manufacturing the pneumatic tires according to the second and third embodiments of the present technology will be described. To vulcanize a green tire, the release agent is coated (preferably baking application) on a bladder in advance to form a coating layer made of a release agent on an outer surface of the bladder. The step of forming the coating layer on the outer surface of the bladder is performed after the application of the release agent, for example, while the release agent is stored at 150° C. for one hour, at 90° C. for four hours, or eight hours at normal temperature. Furthermore, the step of forming the coating layer on the outer surface of the bladder is performed in a range of from one or more times to three or less times. The green tire is vulcanized using the bladder in which the coating layer is formed as described above. In a case where vulcanization is performed by using the bladder including the coating layer made of the release agent in this way, the release agent is transferred onto the tire inner surface of the vulcanized pneumatic tire. In the transferred layer made of the release agent, the release agent is not transferred onto the entire tire inner surface, but is scattered in the tire inner surface.

Instead of using the bladder including the coating layer made of the release agent as described above, vulcanization can be performed using an inner ring core during the vulcanization step for the green tire. Alternatively, the release agent in the tire inner surface can be completely removed by buffing the tire inner surface after vulcanization, or bonding a film to the inner surface of the green tire in advance, applying the release agent to the inner surface of the green tire to which the film has been bonded, and peeling off the film after vulcanization.

As described above, by performing vulcanization using the bladder including the coating layer made of the release agent, performing vulcanization using an inner ring, or the like, the amount of silicon of the release agent detected by fluorescence X-ray analysis at least in the tire inner surface corresponding to the embedment section for the transponder 20 can be set to 10.0 wt % or less, or a thickness of 100 μm or less. In a case where the amount of release agent adheres to the tire inner surface as described above is minute, mutual cancellation of radio waves during communication caused by the release agent can be suppressed, allowing the communication performance of the transponder 20 to be improved.

Note that for the amount of silicone of the release agent layer 30 (amount of silicon of the release agent) or the thickness of the release agent layer 30 (thickness of the release agent), a suitable range of values varies among the pneumatic tires according to the first, second, and third embodiments of the present technology, but that this is not inconsistent because the variation in the suitable range of values among the pneumatic tires according to the first and second embodiments, and the first and third embodiments of the present technology is due to the manufacture of the pneumatic tire according to the first embodiment of the present technology using the normal bladder and due to the manufacture of the pneumatic tires according to the second and third embodiments of the present technology by vulcanization using the bladder including the coating layer made of the release agent or using the inner ring, or due to any other reason.

### EXAMPLE

Tires according to Comparative Examples 1 to 3 and Examples 1 to 9 were manufactured. The tires have a tire size of 265/40ZR 20 and include: a tread portion extending in the tire circumferential direction and having an annular shape, a pair of sidewall portions respectively disposed on both sides of the tread portion, and a pair of bead portions each disposed on an inner side of the sidewall portions in the tire radial direction, a bead filler being disposed on an outer circumference of a bead core of each bead portion, a carcass layer being mounted between the pair of bead portions, a plurality of belt layers being disposed on an outer circumferential side of the carcass layer in the tread portion, and a release agent layer made of a release agent being formed in a tire inner surface, in which a transponder extending along the tire circumferential direction is embedded and in which the release agent layer (components, surface electric resistivity, relative dielectric constant, and thickness) and the position of the transponder (tire radial direction) are set as indicated in Table 1.

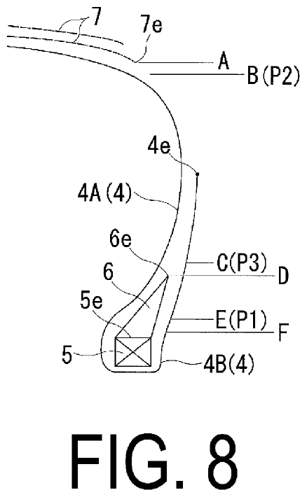

Note that in Table 1, the thickness (μm) of the release agent in the tire inner surface was determined by averaging measurement values obtained by using a scanning electron microscope (SEM-EDX) to measure the thickness of the release agent layer in each of the test tires at four sections in the tire circumferential direction and at three sections in the tire width direction after the end of the manufacturing steps. Additionally, in Table 1, the position of the transponder (tire radial direction) corresponds to each of positions A to F illustrated in FIG. 8.

For these test tires, the communication performance of the transponder was evaluated using a test method described below, and the results are also indicated in Table 1.

Communication Performance (Transponder):

For each test tire, a communication operation with the transponder was performed using a reader/writer. Specifically, the maximum communication distance was measured with the reader-writer set at a power output of 250 mW and a carrier frequency of from 860 MHz to 960 MHz. Evaluation results are expressed as index values with Comparative Example 2 being assigned an index value of 100. Larger index values indicate superior communication performance.

TABLE 1

| | | Comparative | Comparative | Comparative | |
|---|---|---|---|---|---|
| | | Example 1 | Example 2 | Example 3 | Example 1 |
| Release | Component | Yes | No | No | No |
| agent layer | (presence of | | | | |
| | carbon) | | | | |
| | Surface electric | 10⁵ | 10⁸ | 10⁹ | 10⁹ |
| | resistivity | | | | |
| | (Ω · cm) | | | | |
| | Relative | 11 | 11 | 11 | 11 |
| | dielectric | | | | |
| | constant | | | | |
| | Thickness (μm) | 10 | 10 | 10 | 10 |
| Position of | Tire radial | E | E | F | E |
| transponder | direction | | | | |
| Transponder | Communication | 50 | 100 | 30 | 115 |
| evaluation | performance | | | | |

| | | Example 2 | Example 3 | Example 4 | Example 5 |
|---|---|---|---|---|---|
| Release | Component | No | No | No | No |
| agent layer | (presence of | | | | |
| | carbon) | | | | |
| | Surface electric | 10¹⁴ | 10⁹ | 10⁹ | 10⁹ |
| | resistivity | | | | |
| | (Ω · cm) | | | | |
| | Relative | 11 | 10 | 8 | 4 |
| | dielectric | | | | |
| | constant | | | | |
| | Thickness (μm) | 10 | 10 | 10 | 10 |
| Position of | Tire radial | E | E | E | E |
| transponder | direction | | | | |
| Transponder | Communication | 118 | 110 | 112 | 115 |
| evaluation | performance | | | | |
| | | Example 6 | Example 7 | Example 8 | Example 9 |
| Release | Component | No | No | No | No |
| agent layer | (presence of | | | | |
| | carbon) | | | | |
| | Surface electric | 10⁹ | 10⁹ | 10⁹ | 10⁹ |
| | resistivity | | | | |
| | (Ω · cm) | | | | |
| | Relative | 11 | 11 | 11 | 11 |
| | dielectric | | | | |
| | constant | | | | |
| | Thickness (μm) | 20 | 100 | 200 | 210 |
| Position of | Tire radial | E | E | E | E |
| transponder | direction | | | | |
| Transponder | Communication | 115 | 110 | 110 | 102 |
| evaluation | performance | | | | |

As can be seen from Table 1, in the pneumatic tires of Examples 1 to 9, the communication performance of the transponder was improved.

On the other hand, in Comparative Example 1, carbon was contained in the release agent layer formed in the tire inner surface, thus degrading the communication performance of the transponder. In Comparative Example 3, the position of the transponder in the tire radial direction was outside the range specified in an embodiment of the present technology, thus degrading the communication performance of the transponder.

Then, tires according to Comparative Examples 4 to 6 and Examples 10 to 18 were manufactured. The tires include a tread portion extending in the tire circumferential direction and having an annular shape, a pair of sidewall portions respectively disposed on both sides of the tread portion, and a pair of bead portions each disposed on an inner side of the sidewall portions in the tire radial direction, a bead filler being disposed on an outer circumference of a bead core of each bead portion, a carcass layer being mounted between the pair of bead portions, a plurality of belt layers being disposed on an outer circumferential side of the carcass layer in the tread portion, and a release agent layer made of a release agent being formed in a tire inner surface, in which a transponder extending along the tire circumferential direction is embedded and in which the release agent layer (components, surface electric resistivity, relative dielectric constant, and amount) and the position of the transponder (tire radial direction) are set as indicated in Table 2.

Note that in Table 2, the amount of silicone in the release agent layer formed in the tire inner surface was obtained by averaging calculated values calculated based on the amount of silicone measured by using an energy dispersive fluorescent X-ray analyzer (EDX-720, available from Shimadzu Corporation) to measure each test tire at four sections in the tire circumferential direction and three sections in the tire width direction after the end of the manufacturing steps. Measurement conditions include a voltage of 50 kV, a current of 100 μA integration time of 50 seconds, and a collimator of φ10 mm in a vacuum state.

For these test tires, the communication performance of the transponder was evaluated, and the results are also indicated in Table 2. Note that in Table 2, the evaluation results for the communication performance of the transponder are expressed as index values with Comparative Example 5 being assigned the value of 100.

TABLE 2

| | | Comparative | Comparative | Comparative | |
|---|---|---|---|---|---|
| | | Example 4 | Example 5 | Example 6 | Example 10 |
| Release | Component | Yes | No | No | No |
| agent layer | (presence of | | | | |
| | carbon) | | | | |
| | Surface electric | 10⁵ | 10⁸ | 10⁵ | 10⁵ |
| | resistivity | | | | |
| | (Ω · cm) | | | | |
| | Relative | 11 | 11 | 11 | 11 |
| | dielectric | | | | |
| | constant | | | | |
| | Amount (wt %) | 5 | 5 | 5 | 5 |
| Position of | Tire radial | E | E | F | E |
| transponder | direction | | | | |
| Transponder | Communication | 50 | 100 | 30 | 115 |
| evaluation | performance | | | | |
| | | Example 11 | Example 12 | Example 13 | Example 14 |
| Release | Component | No | No | No | No |
| agent layer | (presence of | | | | |
| | carbon) | | | | |
| | Surface electric | 10¹⁴ | 10⁵ | 10⁹ | 10⁹ |
| | resistivity | | | | |
| | (Ω · cm) | | | | |
| | Relative | 11 | 10 | 8 | 4 |
| | dielectric | | | | |
| | constant | | | | |
| | Amount (wt %) | 5 | 5 | 5 | 5 |
| Position of | Tire radial | E | E | E | E |
| transponder | direction | | | | |
| Transponder | Communication | 118 | 110 | 112 | 115 |
| evaluation | performance | | | | |
| | | Example 15 | Example 16 | Example 17 | Example 18 |
| Release | Component | No | No | No | No |
| agent layer | (presence of | | | | |
| | carbon) | | | | |
| | Surface electric | 10⁹ | 10⁹ | 10⁹ | 10⁹ |
| | resistivity | | | | |
| | (Ω · cm) | | | | |
| | Relative | 11 | 11 | 11 | 11 |
| | dielectric | | | | |
| | constant | | | | |
| | Amount (wt %) | 10 | 20 | 25 | 30 |
| Position of | Tire radial | E | E | E | E |
| transponder | direction | | | | |
| Transponder | Communication | 115 | 110 | 110 | 102 |
| evaluation | performance | | | | |

As can be seen from Table 2, in the pneumatic tires of Examples 10 to 18, the communication performance of the transponder was improved.

On the other hand, in Comparative Example 4, carbon was contained in the release agent layer formed in the tire inner surface, thus degrading the communication performance of the transponder. In Comparative Example 6, the position of the transponder in the tire radial direction was outside the range specified in an embodiment of the present technology, thus degrading the communication performance of the transponder.

Then, tires according to Comparative Example 7 and Examples 19 to 37 were manufactured. The tires include: a tread portion extending in the tire circumferential direction and having an annular shape, a pair of sidewall portions respectively disposed on both sides of the tread portion, and a pair of bead portions each disposed on an inner side of the sidewall portions in the tire radial direction, a bead filler being disposed on an outer circumference of a bead core of each bead portion, a carcass layer being mounted between the pair of bead portions, a plurality of belt layers being disposed on an outer circumferential side of the carcass layer in the tread portion, and a release agent layer made of a release agent being formed in a tire inner surface, in which the position of the transponder (tire width direction, tire radial direction, and tire circumferential direction), the distance between the transponder and the tire outer surface, the distance between the transponder and the tire inner surface, the relative dielectric constant of the coating layer, the thickness of the coating layer, and the form of the transponder are set as indicated in Tables 3 and 4.

In the tires of Comparative Example 7 and Examples 19 to 37, the tire inner surface has a surface electric resistivity R of 10⁹ Ω·cm.

Note that in Tables 3 and 4, the position “W” of the transponder (tire width direction) indicates that the transponder is disposed between the bead filler and the carcass layer, the position “X” of the transponder (tire width direction) indicates that the transponder is disposed between the carcass layer and the innerliner layer, the position “Y” of the transponder (tire width direction) indicates that the transponder is disposed between the carcass layer and the sidewall rubber layer in contact with the sidewall rubber layer, and the position “Z” of the transponder (tire width direction) indicates that the transponder is disposed between the carcass layer and the rim cushion rubber layer and in contact with the rim cushion rubber layer. Additionally, in Tables 3 and 4, the position of the transponder (tire radial direction) corresponds to each of the positions A to F illustrated in FIG. 8. Furthermore, in Tables 3 and 4, the position of the transponder (tire circumferential direction) indicates the distance (mm) measured from the center of the transponder to the splice portion of the tire component in the tire circumferential direction.

Tire evaluation (durability, scratch resistance, and appearance) and transponder evaluation (communication performance, durability, scratch resistance, and damage resistance) were conducted on the test tires using a test method described below, and the results are indicated in Tables 3 and 4. Note that the evaluation results for the communication performance of the transponder are expressed as index values, with Example 19 being assigned as the reference 100.

Durability (Tire and Transponder):

Each of the test tires was mounted on a wheel of a standard rim, and a traveling test was performed by using a drum testing machine at an air pressure of 120 kPa, 102% of the maximum load, and a traveling speed of 81 km/h. After the test was performed, the traveling distance at the time of occurrence of a failure in the tire was measured. Evaluation results are expressed as four levels: “Excellent” indicates that the traveling distance reached 6480 km. “Good” indicates that the traveling distance was 4050 km or more and less than 6480 km, “Fair” indicates that the traveling distance was 3240 km or more and less than 4050 km, and “Poor” indicates that the traveling distance was less than 3240 km. Furthermore, after traveling was ended, the tire outer surface of each test tire was visually checked, and whether the tire failure originated from the transponder was checked. Evaluation results indicate the presence of the failure.

Scratch Resistance (Tire):

Each test tire was assembled on a wheel of a standard rim and mounted on a test vehicle, and a traveling test was conducted in which the vehicle traveled at an air pressure of 230 kPa and a traveling speed of 20 km/h while being in contact with a curb of 100 mm in height. After traveling, the presence of damage to the tire outer surface was visually checked. Evaluation results indicate the presence of damage to the tire outer surface.

Appearance (Tire):

For each test tire, the portion of the tire outer surface corresponding to the arrangement section for the transponder was visually checked. In the evaluation results, “Good” indicates that the tire outer surface had no unevenness caused by the arrangement of the transponder, and “Poor” indicates that the tire outer surface had unevenness.

Scratch Resistance (Transponder):

Each test tire was assembled on a wheel of a standard rim and mounted on a test vehicle, and a traveling test was conducted in which the vehicle traveled at an air pressure of 230 kPa and a traveling speed of 20 km/h and ran onto a curb of 100 mm in height. After traveling, the portion of the tire outer surface corresponding to the arrangement section for the transponder was visually checked. The evaluation results indicate the presence of damage to the tire outer surface caused by the arrangement of the transponder.

Damage Resistance while Tire is Mounted on Rim (transponder):

For each test tire, the portion of the tire inner surface corresponding to the arrangement section for the transponder was visually checked when the rim was replaced. The evaluation results indicate the presence of damage to the transponder caused by damage to the innerliner.

TABLE 3

| | | Example 19 | Example 20 | Example 21 | Example 22 |
|---|---|---|---|---|---|
| Position of | Tire width | Z | Z | W | Y |
| transponder | direction | | | | |
| | Tire radial | E | E | E | E |
| | direction | | | | |
| | Tire | 5 | 8 | 10 | 10 |
| | circumferential | | | | |
| | direction | | | | |
| Distance between transponder | | 2 or | 2 or | 2 or | 2 or |
| and tire outer surface (mm) | | more | more | more | more |
| Distance between transponder | | — | — | — | — |
| and tire inner surface (mm) | | | | | |
| Relative dielectric constant | | — | — | — | — |
| of coating layer | | | | | |
| Thickness of coating layer (mm) | | — | — | — | — |
| Form of transponder | | Plate-like | Plate-like | Plate-like | Plate-like |
| | | shape | shape | shape | shape |
| Tire evaluation | Durability | Marginal | Good | Excellent | Excellent |
| | Scratch resistance | No | No | No | No |
| | (presence of damage) | | | | |
| | Appearance | — | — | — | — |
| Transponder | Communication | 100 | 100 | 100 | 110 |
| evaluation | performance | | | | |
| | Durability | Yes | Yes | No | No |
| | (presence of failure) | | | | |
| | Scratch resistance | Yes | Yes | Yes | Yes |
| | (presence of damage) | | | | |
| | Damage resistance | — | — | — | — |
| | (presence of damage) | | | | |

| | | Example 23 | Example 24 | Example 25 |
|---|---|---|---|---|
| Position of | Tire width | Z | Z | X |
| transponder | direction | | | |
| | Tire radial | E | E | E |
| | direction | | | |
| | Tire | 10 | 10 | 10 |
| | circumferential | | | |
| | direction | | | |
| Distance between transponder | | 2 or | 1 | — |
| and tire outer surface (mm) | | more | | |
| Distance between transponder | | — | — | 0.5 |
| and tire inner surface (mm) | | | | |
| Relative dielectric constant | | — | — | — |
| of coating layer | | | | |
| Thickness of coating layer (mm) | | — | — | — |
| Form of transponder | | Plate-like | Plate-like | Plate-like |
| | | shape | shape | shape |
| Tire evaluation | Durability | Excellent | Excellent | Excellent |
| | Scratch resistance | No | Yes | No |
| | (presence of damage) | | | |
| | Appearance | — | — | — |
| Transponder | Communication | 110 | 100 | 100 |
| evaluation | performance | | | |
| | Durability | No | No | No |
| | (presence of failure) | | | |
| | Scratch resistance | Yes | Yes | No |
| | (presence of damage) | | | |
| | Damage resistance | — | — | Yes |
| | (presence of damage) | | | |
| | | Comparative | | |
| | | Example 7 | Example 26 | Example 27 |
| Position of | Tire width | X | X | Z |
| transponder | direction | | | |
| | Tire radial | A | E | D |
| | direction | | | |
| | Tire | 10 | 10 | 10 |
| | circumferential | | | |
| | direction | | | |
| Distance between transponder | | — | — | 2 or |
| and tire outer surface (mm) | | | | more |
| Distance between transponder | | 0.5 | 1.0 | — |
| and tire inner surface (mm) | | | | |
| Relative dielectric constant | | — | — | — |
| of coating layer | | | | |
| Thickness of coating layer (mm) | | — | — | — |
| Form of transponder | | Plate-like | Plate-like | Plate-like |
| | | shape | shape | shape |
| Tire evaluation | Durability | Excellent | Excellent | Excellent |
| | Scratch resistance | No | No | No |
| | (presence of damage) | | | |
| | Appearance | — | — | — |
| Transponder | Communication | 50 | 100 | 100 |
| evaluation | performance | | | |
| | Durability | No | No | No |
| | (presence of failure) | | | |
| | Scratch resistance | No | No | Yes |
| | (presence of damage) | | | |
| | Damage resistance | Yes | No | — |
| | (presence of damage) | | | |

TABLE 4

| | | Example 28 | Example 29 | Example 30 | Example 31 |
|---|---|---|---|---|---|
| Position of | Tire width | Y | Y | Z | Z |
| transponder | direction | | | | |
| | Tire radial | B | C | E | E |
| | direction | | | | |
| | Tire | 10 | 10 | 10 | 10 |
| | circumferential | | | | |
| | direction (mm) | | | | |
| Distance between transponder | | 2 or | 2 or | 2 or | 2 or |
| and tire outer surface (mm) | | more | more | more | more |
| Distance between transponder | | — | — | — | — |
| and tire inner surface (mm) | | | | | |
| Relative dielectric constant | | — | — | 3.5 | 7 |
| of coating layer | | | | | |
| Thickness of coating layer (mm) | | — | — | 0.2 | 0.2 |
| Form of transponder | | Plate-like | Plate-like | Plate-like | Plate-like |
| | | shape | shape | shape | shape |
| Tire evaluation | Durability | Excellent | Excellent | Excellent | Excellent |
| | Scratch resistance | No | No | No | No |
| | (presence of damage) | | | | |
| | Appearance | — | — | Good | Good |
| transponder | Communication | 110 | 110 | 115 | 110 |
| evaluation | performance | | | | |
| | Durability | No | No | No | No |
| | (presence of failure) | | | | |
| | Scratch resistance | Yes | Yes | Yes | Yes |
| | (presence of damage) | | | | |
| | Damage resistance | — | — | — | — |
| | (presence of damage) | | | | |

| | | Example 32 | Example 33 | Example 34 |
|---|---|---|---|---|
| Position of | Z | Z | Z | Z |
| transponder | E | E | E | E |
| | 10 | 10 | 10 | 10 |
| Distance between transponder | | 2 or more | 2 or more | 2 or more |
| and tire outer surface (mm) | | | | |
| Distance between transponder | | — | — | — |
| and tire inner surface (mm) | | | | |
| Relative dielectric constant | | 8 | 7 | 7 |
| of coating layer | | | | |
| Thickness of coating layer (mm) | | 0.2 | 0.5 | 1.5 |
| Form of transponder | | Plate-like | Plate-like | Plate-like |
| | | shape | shape | shape |
| Tire evaluation | Excellent | Excellent | Excellent | Excellent |
| | No | No | No | No |
| | Good | Good | Good | Good |
| Transponder | 100 | 120 | 130 | 130 |
| evaluation | No | No | No | No |
| | Yes | Yes | Yes | Yes |
| | — | — | — | — |

| | | Example 35 | Example 36 | Example 37 |
|---|---|---|---|---|
| Position of | Tire width direction | Z | Z | Z |
| transponder | Tire radial direction | E | E | E |
| | Tire circumferential | 10 | 10 | 8 |
| | direction (mm) | | | |
| Distance between transponder | | 2 or more | 2 or more | 2 or more |
| and tire outer surface (mm) | | | | |
| Distance between transponder | | — | — | — |
| and tire inner surface (mm) | | | | |
| Relative dielectric constant | | 7 | 7 | — |
| of coating layer | | | | |
| Thickness of coating layer (mm) | | 3.0 | 3.5 | — |
| Form of transponder | | Plate-like | Plate-like | Pillar-like |
| | | shape | shape | shape |
| Tire evaluation | Durability | Excellent | Excellent | Good |
| | Scratch resistance | No | No | No |
| | (presence of damage) | | | |
| | Appearance | Good | Poor | — |
| Transponder | Communication | 130 | 130 | 100 |
| evaluation | performance | | | |
| | Durability | No | No | No |
| | (presence of failure) | | | |
| | Scratch resistance | Yes | Yes | Yes |
| | (presence of damage) | | | |
| | Damage resistance | — | — | — |
| | (presence of damage ) | | | |

As can be seen from Tables 3 and 4, the tire evaluation and the transponder evaluation confirmed that Example 20 to 37 produce various improvement effects. On the other hand, in Comparative Example 7, the position of the transponder in the tire radial direction was outside the range specified in an embodiment of the present technology, degrading the communication performance of the transponder.

Then, tires according to Comparative Examples 41 to 45 and Examples 41 to 46 were manufactured. The tires have a tire size of 265/40ZR 20 and include: a tread portion extending in the tire circumferential direction and having an annular shape, a pair of sidewall portions respectively disposed on both sides of the tread portion, and a pair of bead portions each disposed on an inner side of the sidewall portions in the tire radial direction, a bead filler being disposed on an outer circumference of a bead core of each bead portion, a carcass layer being mounted between the pair of bead portions, and a plurality of belt layers being disposed on an outer circumferential side of the carcass layer in the tread portion, in which a transponder extending along the tire circumferential direction is embedded and in which the release agent (removal method and amount) and the position of the transponder (tire radial direction) are set as indicated in Table 5.

Note that, in Table 5, a “Normal” vulcanization method indicates that vulcanization molding was performed using a normal bladder, an “Inner ring” vulcanization method indicates that vulcanization molding was performed using an inner ring, and a “Coating” vulcanization method indicates that vulcanization molding was performed using a bladder including a coating layer made of a release agent. Additionally, in Table 5, the amount of release agent (silicon) adhering to the tire inner surface was obtained by averaging calculated values calculated based on the amount of release agent (silicon) measured by using the energy dispersive fluorescent X-ray analyzer (EDX-720, available from Shimadzu Corporation) to measure each test tire at four sections in the tire circumferential direction and three sections in the tire width direction after the end of the manufacturing steps. Measurement conditions include a voltage of 50 kV, a current of 100 μA, integration time of 50 seconds, and a collimator of φ10 mm in a vacuum state. Furthermore, in Table 5, the position of the transponder (tire radial direction) corresponds to each of the positions A to F illustrated in FIG. 8.

Tire evaluation (air retention properties) and transponder evaluation (communication performance) were conducted on the test tires using a test method described below, and results are also indicated in Table 5. Note that in Table 5, the evaluation results for the communication performance of the transponder are expressed as index values with Comparative Example 42 being assigned the value of 100.

Air Retention Properties (Tire):

Each of the test tires was assembled on a wheel of a standard rim, and was left for 24 hours at an air pressure of 270 kPa and a temperature of 21′C. Then, air pressure was measured for 42 days with the initial air pressure set to 250 kPa. The gradient of an air leakage amount from the 15th day through the 42nd day was determined. The evaluation results are represented with the use of reciprocals of the measurement values and by index values with Comparative Example 42 being assigned the value of 100. The larger index values mean excellent air retention properties.

TABLE 5

| | | Comparative | Comparative | Comparative |
|---|---|---|---|---|
| | | Example 41 | Example 42 | Example 43 |
| Vulcanization method | | Normal | Normal | Normal |
| Release agent | Removal method | — | — | High pressure |
| | | | | cleaning |
| | Amount (wt %) | 45.0 | 15.0 | 15.0 |
| Position of | Tire radial | E | E | E |
| transponder | direction | | | |
| Tire | Air retention | 100 | 100 | 100 |
| evaluation | properties | | | |
| Transponder | Communication | 50 | 100 | 85 |
| evaluation | performance | | | |

| | | Example 41 | Example 42 | Example 43 | Example 44 |
|---|---|---|---|---|---|
| Vulcanization method | | Normal | Normal | Inner | Coating |
| | | | | ring | |
| Release agent | Removal method | Buffing | Film | — | — |
| | Amount (wt %) | 0.0 | 0.0 | 0.0 | 0.1 |
| Position of | Tire radial | E | E | E | E |
| transponder | direction | | | | |
| Tire | Air retention | 92 | 99 | 100 | 100 |
| evaluation | properties | | | | |
| Transponder | Communication | 110 | 110 | 110 | 110 |
| evaluation | performance | | | | |
| | | | | Comparative | Comparative |
| | | Example 45 | Example 46 | Example 44 | Example 45 |
| Vulcanization method | | Coating | Coating | Coating | Coating |
| Release agent | Removal method | — | — | — | — |
| | Amount (wt %) | 2.5 | 10.0 | 2.0 | 11.0 |
| Position of | Tire radial | E | E | F | E |
| transponder | direction | | | | |
| Tire | Air retention | 100 | 100 | 100 | 100 |
| evaluation | properties | | | | |
| Transponder | Communication | 110 | 105 | 30 | 100 |
| evaluation | performance | | | | |

As can be seen from Table 5, in Examples 41 to 46, the communication performance of the transponder was improved. In Examples 43 to 46, an inner ring or a bladder including a coating layer made of a release agent was used in the vulcanization step, thus maintaining the air retention properties of the tire.

On the other hand, in Comparative Example 41, vulcanization molding was performed using a normal bladder, thus degrading the communication performance of the transponder. In Comparative Example 43, the tire inner surface was high pressure cleaned after normal vulcanization molding, and a large amount of release agent remained on the tire inner surface. The amount exceeded the value specified in an embodiment of the present technology, thus degrading the communication performance of the transponder. In Comparative Example 44, the position of the transponder in the tire radial direction was outside the range specified in an embodiment of the present technology, thus degrading the communication performance of the transponder. In Comparative Example 45, the communication performance of the transponder was not improved because the amount of release agent in the tire inner surface exceeded the amount specified in an embodiment of the present technology.

Then, tires according to Comparative Examples 46 to 50 and Examples 47 to 52 were manufactured. The tires include: a tread portion extending in the tire circumferential direction and having an annular shape, a pair of sidewall portions respectively disposed on both sides of the tread portion, and a pair of bead portions each disposed on an inner side of the sidewall portions in the tire radial direction, a bead filler being disposed on an outer circumference of a bead core of each bead portion, a carcass layer being mounted between the pair of bead portions, and a plurality of belt layers being disposed on an outer circumferential side of the carcass layer in the tread portion, in which a transponder extending along the tire circumferential direction is embedded and in which the release agent (removal method and thickness) and the position of the transponder (tire radial direction) are set as indicated in Table 6.

Note that in Table 6, the thickness (μm) of the release agent adhering to the tire inner surface was determined by averaging measurement values obtained by using the scanning electron microscope (SEM-EDX) to measure the thickness of the release agent in each of the test tires at four sections in the tire circumferential direction and at three sections in the tire width direction after the end of the manufacturing steps. In Table 6, the position of the transponder (tire radial direction) corresponds to each of the positions A to F illustrated in FIG. 8.

Tire evaluation (air retention properties) and transponder evaluation (communication performance) were conducted on the test tires, and results are also indicated in Table 6. Note that in Table 6, the evaluation results for the air retention properties of the tire and the communication performance of the transponder are expressed as index values with Comparative Example 47 being assigned the value of 100.

TABLE 6

| | | Comparative | Comparative | Comparative |
|---|---|---|---|---|
| | | Example 46 | Example 47 | Example 48 |
| Vulcanization method | | Normal | Normal | Normal |
| Release agent | Removal method | — | — | High pressure |
| | | | | cleaning |
| | Thickness (μm) | 200 | 200 | 130 |
| Position of | Tire radial | E | E | E |
| transponder | direction | | | |
| Tire | Air retention | 100 | 100 | 100 |
| evaluation | properties | | | |
| Transponder | Communication | 50 | 100 | 85 |
| evaluation | performance | | | |

| | | Example 47 | Example 48 | Example 49 | Example 50 |
|---|---|---|---|---|---|
| Vulcanization method | | Normal | Normal | Inner | Coating |
| | | | | ring | |
| Release agent | Removal method | Buffing | Film | — | — |
| | Thickness (μm) | 0 | 0 | 0 | 10 |
| Position of | Tire radial | E | E | E | E |
| transponder | direction | | | | |
| Tire | Air retention | 92 | 99 | 100 | 100 |
| evaluation | properties | | | | |
| Transponder | Communication | 110 | 110 | 110 | 110 |
| evaluation | performance | | | | |
| | | | | Comparative | Comparative |
| | | Example 51 | Example 52 | Example 49 | Example 50 |
| Vulcanization method | | Coating | Coating | Coating | Coating |
| Release agent | Removal method | — | — | — | — |
| | Thickness (μm) | 50 | 100 | 30 | 110 |
| Position of | Tire radial | E | E | F | E |
| transponder | direction | | | | |
| Tire | Air retention | 100 | 100 | 100 | 100 |
| evaluation | properties | | | | |
| Transponder | Communication | 110 | 105 | 30 | 100 |
| evaluation | performance | | | | |

As can be seen from Table 6, in Examples 47 to 52, the communication performance of the transponder was improved. In Examples 49 to 52, an inner ring or a bladder including a coating layer made of a release agent was used in the vulcanization step, thus maintaining the air retention properties of the tire.

On the other hand, in Comparative Example 46, vulcanization molding was performed using a normal bladder, thus degrading the communication performance of the transponder. In Comparative Example 48, the tire inner surface was high pressure cleaned after normal vulcanization molding, and a large amount of release agent remained on the tire inner surface. The amount exceeded the value specified in an embodiment of the present technology, thus degrading the communication performance of the transponder. In Comparative Example 49, the position of the transponder in the tire radial direction was outside the range specified in an embodiment of the present technology, thus degrading the communication performance of the transponder. In Comparative Example 50, the thickness of the release agent in the tire inner surface exceeded the amount specified in an embodiment of the present technology, thus preventing the communication performance of the transponder from being improved.

Then, tires according to Comparative Example 51 and Examples 53 to 71 were manufactured. The tires include: a tread portion extending in the tire circumferential direction and having an annular shape, a pair of sidewall portions respectively disposed on both sides of the tread portion, and a pair of bead portions each disposed on an inner side of the sidewall portions in the tire radial direction, a bead filler being disposed on an outer circumference of a bead core of each bead portion, a carcass layer being mounted between the pair of bead portions, and a plurality of belt layers being disposed on an outer circumferential side of the carcass layer in the tread portion, in which a transponder extending along the tire circumferential direction is embedded and in which the position of the transponder (tire width direction, tire radial direction, and tire circumferential direction), the distance between the transponder and the tire outer surface, the distance between the transponder and the tire inner surface, the relative dielectric constant of the coating layer, the thickness of the coating layer, and the form of the transponder are set as indicated in Tables 7 and 8.

In this regard, the tires of Comparative Example 51 and Examples 53 to 71 are vulcanized using a bladder including a coating layer made of a release agent, and the amount of release agent (silicon) adhering to the tire inner surface is 0.1 wt %.

Tire evaluation (durability, scratch resistance, and appearance) and transponder evaluation (communication performance, durability, scratch resistance, and damage resistance) were conducted on the test tires, and results are indicated in Tables 7 and 8. The evaluation results for the communication performance of the transponder are expressed as index values, with Example 53 being assigned the value of 100.

TABLE 7

| | | Example 53 | Example 54 | Example 55 | Example 56 |
|---|---|---|---|---|---|
| Position of | Tire width direction | Z | Z | W | Y |
| transponder | Tire radial direction | E | E | E | E |
| | Tire circumferential | 5 | 8 | 10 | 10 |
| | direction (mm) | | | | |
| Distance between transponder | | 2 or | 2 or | 2 or | 2 or |
| and tire outer surface (mm) | | more | more | more | more |
| Distance between transponder | | — | — | — | — |
| and tire inner surface (mm) | | | | | |
| Relative dielectric constant | | — | — | — | — |
| of coating layer | | | | | |
| Thickness of coating layer (mm) | | — | — | — | — |
| Form of transponder | | Plate-like | Plate-like | Plate-like | Plate-like |
| | | shape | shape | shape | shape |
| Tire evaluation | Durability | Fair | Good | Excellent | Excellent |
| | Scratch resistance | No | No | No | No |
| | (presence of damage) | | | | |
| | Appearance | — | — | — | — |
| Transponder | Communication | 100 | 100 | 100 | 110 |
| evaluation | performance | | | | |
| | Durability (presence | Yes | Yes | No | No |
| | of failure) | | | | |
| | Scratch resistance | Yes | Yes | Yes | Yes |
| | (presence of damage) | | | | |
| | Damage resistance | — | — | — | — |
| | (presence of damage) | | | | |

| | | Example 57 | Example 58 | Example 59 |
|---|---|---|---|---|
| Position of | Tire width direction | Z | Z | X |
| transponder | Tire radial direction | E | E | E |
| | Tire circumferential | 10 | 10 | 10 |
| | direction (mm) | | | |
| Distance between transponder | | 2 or | 1 | — |
| and tire outer surface (mm) | | more | | |
| Distance between transponder | | — | — | 0.5 |
| and tire inner surface (mm) | | | | |
| Relative dielectric constant | | — | — | — |
| of coating layer | | | | |
| Thickness of coating layer (mm) | | — | — | — |
| Form of transponder | | Plate-like | Plate-like | Plate-like |
| | | shape | shape | shape |
| Tire evaluation | Durability | Excellent | Excellent | Excellent |
| | Scratch resistance | No | Yes | No |
| | (presence of damage) | | | |
| | Appearance | — | — | — |
| Transponder | Communication | 110 | 100 | 100 |
| evaluation | performance | | | |
| | Durability (presence | No | No | No |
| | of failure) | | | |
| | Scratch resistance | Yes | Yes | No |
| | (presence of damage) | | | |
| | Damage resistance | — | — | Yes |
| | (presence of damage) | | | |
| | | Comparative | | |
| | | Example 51 | Example 60 | Example 61 |
| Position of | Tire width direction | X | X | z |
| transponder | Tire radial direction | A | E | D |
| | Tire circumferential | 10 | 10 | 10 |
| | direction (mm) | | | |
| Distance between transponder | | — | — | 2 or |
| and tire outer surface (mm) | | | | more |
| Distance between transponder | | 0.5 | 1.0 | — |
| and tire inner surface (mm) | | | | |
| Relative dielectric constant | | — | — | — |
| of coating layer | | | | |
| Thickness of coating layer (mm) | | — | — | — |
| Form of transponder | | Plate-like | Plate-like | Plate-like |
| | | shape | shape | shape |
| Tire evaluation | Durability | Excellent | Excellent | Excellent |
| | Scratch resistance | No | No | No |
| | (presence of damage) | | | |
| | Appearance | — | — | — |
| Transponder | Communication | 50 | 100 | 100 |
| evaluation | performance | | | |
| | Durability (presence | No | No | No |
| | of failure) | | | |
| | Scratch resistance | No | No | Yes |
| | (presence of damage) | | | |
| | Damage resistance | Yes | No | — |
| | (presence of damage) | | | |

TABLE 8

| | | Example 62 | Example 63 | Example 64 | Example 65 |
|---|---|---|---|---|---|
| Position of | Tire width direction | Y | Y | Z | Z |
| transponder | Tire radial direction | B | C | E | E |
| | Tire circumferential | 10 | 10 | 10 | 10 |
| | direction (mm) | | | | |
| Distance between transponder | | 2 or | 2 or | 2 or | 2 or |
| and tire outer surface (mm) | | more | more | more | more |
| Distance between transponder | | — | — | — | — |
| and tire inner surface (mm) | | | | | |
| Relative dielectric constant | | — | — | 3.5 | 7 |
| of coating layer | | | | | |
| Thickness of coating layer (mm) | | — | — | 0.2 | 0.2 |
| Form of transponder | | Plate-like | Plate-like | Plate-like | Plate-like |
| | | shape | shape | shape | shape |
| Tire evaluation | Durability | Excellent | Excellent | Excellent | Excellent |
| | Scratch resistance | No | No | No | No |
| | (presence of damage) | | | | |
| | Appearance | — | — | Good | Good |
| Transponder | Communication | 110 | 110 | 115 | 110 |
| evaluation | performance | | | | |
| | Durability (presence | No | No | No | No |
| | of failure) | | | | |
| | Scratch resistance | Yes | Yes | Yes | Yes |
| | (presence of damage) | | | | |
| | Damage resistance | — | — | — | — |
| | (presence of damage) | | | | |

| | | Example 66 | Example 67 | Example 68 |
|---|---|---|---|---|
| Position of | Tire width direction | Z | Z | Z |
| transponder | Tire radial direction | E | E | E |
| | Tire circumferential | 10 | 10 | 10 |
| | direction (mm) | | | |
| Dis tance between transponder | | 2 or | 2 or | 2 or |
| and tire outer surface (mm) | | more | more | more |
| Distance between transponder | | — | — | — |
| and tire inner surface (mm) | | | | |
| Relative dielectric constant | | 8 | 7 | 7 |
| of coating layer | | | | |
| Thickness of coating layer (mm) | | 0.2 | 0.5 | 1.5 |
| Form of transponder | | Plate-like | Plate-like | Plate-like |
| | | shape | shape | shape |
| Tire evaluation | Durability | Excellent | Excellent | Excellent |
| | Scratch resistance | No | No | No |
| | (presence of damage) | | | |
| | Appearance | Good | Good | Good |
| Transponder | Communication | 100 | 120 | 130 |
| evaluation | performance | | | |
| | Durability (presence | No | No | No |
| | of failure) | | | |
| | Scratch resistance | Yes | Yes | Yes |
| | (presence of damage) | | | |
| | Damage resistance | — | — | — |
| | (presence of damage) | | | |
| | | Example 69 | Example 70 | Example 71 |
| Position of | Tire width direction | Z | Z | Z |
| transponder | Tire radial direction | E | E | E |
| | Tire circumferential | 10 | 10 | 8 |
| | direction (mm) | | | |
| Distance between transponder | | 2 or | 2 or | 2 or |
| and tire outer surface (mm) | | more | more | more |
| Distance between transponder | | — | — | — |
| and tire inner surface (mm) | | | | |
| Relative dielectric constant | | 7 | 7 | — |
| of coating layer | | | | |
| Thickness of coating layer (mm) | | 3.0 | 3.5 | — |
| Form of transponder | | Plate-like | Plate-like | Pillar-like |
| | | shape | shape | shape |
| Tire evaluation | Durability | Excellent | Excellent | Good |
| | Scratch resistance | No | No | No |
| | (presence of damage) | | | |
| | Appearance | Good | Poor | — |
| Transponder | Communication | 130 | 130 | 100 |
| evaluation | performance | | | |
| | Durability (presence | No | No | No |
| | of failure) | | | |
| | Scratch resistance | Yes | Yes | Yes |
| | (presence of damage) | | | |
| | Damage resistance | — | — | — |
| | (presence of damage) | | | |

As can be seen from Tables 7 and 8, in Examples 54 to 71, the tire evaluation and the transponder evaluation confirmed various improvement effects. On the other hand, in Comparative Example 51, the position of the transponder in the tire radial direction was outside the range specified in an embodiment of the present technology, thus degrading the communication performance of the transponder.

1. A pneumatic tire comprising:
a tread portion extending in a tire circumferential direction and having an annular shape;
a pair of sidewall portions respectively disposed on both sides of the tread portion; and
a pair of bead portions each disposed on an inner side of the sidewall portions in a tire radial direction,
a bead filler being disposed on an outer circumference of a bead core of each bead portion,
at least one carcass layer being mounted between the pair of bead portions,
a plurality of belt layers being disposed on an outer circumferential side of the carcass layer in the tread portion, and
a release agent layer made of a release agent being formed in a tire inner surface,
a transponder that extends along the tire circumferential direction being embedded between a position located on an outer side of and 15 mm away from an upper end of the bead core in the tire radial direction and a position located on an inner side of and 5 mm away from an end of the belt layer in the tire radial direction, and
the tire inner surface in which the release agent layer is formed having a surface electric resistivity R ranging from 10⁹ Ω·cm to 10¹⁵ Ω·cm.

2. The pneumatic tire according to claim 1, wherein the release agent layer includes 95 wt % or more of insulator.

3. The pneumatic tire according to claim 2, wherein an amount of silicone constituting the insulator of the release agent layer is 80 wt % or more.

4. The pneumatic tire according to claim 1, wherein the release agent layer has a greater electric resistivity than a rubber member adjacent to the release agent layer.

5. The pneumatic tire according to claim 1, wherein the release agent layer has a relative dielectric constant of 10 or less.

6. The pneumatic tire according to claim 1, wherein the release agent layer has a thickness ranging from 20 μm to 200 μm.

7. The pneumatic tire according to claim 1, wherein an amount of silicone detected in the release agent layer by fluorescence X-ray analysis ranges from 10 wt % to 25 wt %.

8. A pneumatic tire comprising:
a tread portion extending in a tire circumferential direction and having an annular shape;
a pair of sidewall portions respectively disposed on both sides of the tread portion; and
a pair of bead portions each disposed on an inner side of the sidewall portions in a tire radial direction,
a bead filler being disposed on an outer circumference of a bead core of each bead portion,
at least one carcass layer being mounted between the pair of bead portions, and
a plurality of belt layers being disposed on an outer circumferential side of the carcass layer in the tread portion,
a transponder that extends along the tire circumferential direction being embedded between a position located on an outer side of and 15 mm away from an upper end of the bead core in the tire radial direction and a position located on an inner side of and 5 mm away from an end of the belt layer in the tire radial direction, and
an amount of silicon of a release agent detected by fluorescence X-ray analysis at least in a tire inner surface corresponding to an embedment section for the transponder being 10.0 wt % or less.

9. A pneumatic tire comprising:
a tread portion extending in a tire circumferential direction and having an annular shape;
a pair of sidewall portions respectively disposed on both sides of the tread portion; and
a pair of bead portions each disposed on an inner side of the sidewall portions in a tire radial direction,
a bead filler being disposed on an outer circumference of a bead core of each bead portion,
at least one carcass layer being mounted between the pair of bead portions, and
a plurality of belt layers being disposed on an outer circumferential side of the carcass layer in the tread portion,
a transponder that extends along the tire circumferential direction being embedded between a position located on an outer side of and 15 mm away from an upper end of the bead core in the tire radial direction and a position located on an inner side of and 5 mm away from an end of the belt layer in the tire radial direction, and
a release agent having a thickness of 100 μm or less, the thickness detected by an electron microscope at least in a tire inner surface corresponding to an embedment section for the transponder.

10. The pneumatic tire according to claim 8, wherein an amount of silicon of the release agent ranges from 0.1 wt % to 10.0 wt %.

11. The pneumatic tire according to claim 9, wherein the release agent has a thickness ranging from 0.1 μm to 100 μm.

12. The pneumatic tire according to claim 1, wherein a center of the transponder is disposed 10 mm or more away from a splice portion of a tire component in the tire circumferential direction.

13. The pneumatic tire according to claim 1, wherein the transponder is disposed between the carcass layer and a rubber layer disposed in the sidewall portion on an outer side of the carcass layer, the transponder in contact with the rubber layer.

14. The pneumatic tire according to claim 13, wherein a distance between a cross-sectional center of the transponder and a tire outer surface is 2 mm or more.

15. The pneumatic tire according to claim 1, wherein
an innerliner layer is disposed on the tire inner surface along the carcass layer, and
the transponder is disposed between the carcass layer and the innerliner layer.

16. The pneumatic tire according to claim 15, wherein a distance between a cross-sectional center of the transponder and the tire inner surface is 1 mm or more.

17. The pneumatic tire according to claim 1, wherein the transponder is disposed between a position located on an outer side of and 5 mm away from an upper end of the bead filler in the tire radial direction and a position located on the inner side of and 5 mm away from the end of the belt layer in the tire radial direction.

18. The pneumatic tire according to claim 1, wherein
the transponder is covered with a coating layer, and
the coating layer has a relative dielectric constant of 7 or less.

19. The pneumatic tire according to claim 1, wherein
the transponder is covered with the coating layer, and
the coating layer has a thickness ranging from 0.5 mm to 3.0 mm.

20. The pneumatic tire according to claim 1, wherein
the transponder comprises an IC substrate storing data and an antenna transmitting and receiving data, and
the antenna has a helical shape.
